(19) United States
(12) Patent Application Publication
(10) Pub. No.: US 2006/0003095 A1
(43) Pub. Date: Jan. 5, 2006

(54) Greater angle and overhanging materials deposition

(75) Inventors: James L. Bullen, Edgewood, NM (US); David M. Keicher, Albuquerque, NM (US)

Correspondence Address: PEACOCK MYERS, P.C., 201 THIRD STREET, N.W., SUITE 1340, ALBUQUERQUE, NM, 87102, US

(73) Assignee: Optomec Design Company, Albuquerque, NM (US)

(21) Appl. No.: 11/121,630

(22) Filed: May 3, 2005

Related U.S. Application Data
(63) Continuation-in-part of application No. 10/980,455, filed on Nov. 2, 2004.
Application No. 10/980,455 is a continuation of application No. 10/128,658, filed on Apr. 22, 2002, now Pat. No. 6,811,744.
Application No. 10/128,658 is a continuation-in-part of application No. 09/568,207, filed on May 9, 2000, now Pat. No. 6,391,251.
(60) Provisional application No. 60/143,142, filed on Jul. 7, 1999.
(60) Provisional application No. 60/567,982, filed on May 4, 2004.

(51) Int. Cl. B05D 5/00

(52) U.S. Cl. 427/180; 427/256

(57) ABSTRACT

Apparatuses and methods for producing greater angle or overhanging deposits on a structure. Nozzles for propelling powder at a target or structure for subsequent laser processing are preferably at a greater angle of powder entry than currently used. The nozzles are arranged around the laser beam and can be individual or disposed around an annular ring. The individual nozzles can be interchangeable with the annular ring. Discrete nozzles can be used in addition to or in place of the other nozzles, allowing angles of powder entry up to approximately 180°. The nozzles may be translated or rotated with respect to the target along or about multiple axes. Also a method for temporarily supporting an overhang using weaker material under the overhang. The weaker material can be removed after the overhang is fabricated and solidified.

### CROSS-REFERENCE TO RELATED APPLICATIONS

This application claims the benefit of the filing of U.S. Provisional Patent Application Ser. No. 60/567,982, entitled “High Angle Deposition Nozzles and Overhang Support Structures,” filed on May 4, 2004. This application is also a continuation-in-part application of U.S. patent application Ser. No. 10/980,455, entitled “Powder Feeder for Material Deposition Systems,” filed on Nov. 2, 2004, which is a continuation application of U.S. patent application Ser. No. 10/128,658, now U.S. Pat. No. 6,811,744, entitled “Forming Structures from CAD Solid Models,” filed on Apr. 22, 2002, which is a continuation-in-part application of U.S. patent application Ser. No. 09/568,207, now U.S. Pat. No. 6,391,251, entitled “Forming Structures from CAD Solid Models,” filed on May 9, 2000, which claims the benefit of the filing of U.S. Provisional Patent Application Ser. No. 60/143,142, entitled “Manufacturable Geometries for Thermal Management of Complex Three-Dimensional Shapes,” filed on Jul. 7, 1999. The specifications and claims of all of the above references are hereby incorporated herein by reference.

### BACKGROUND OF THE INVENTION

1. Field of the Invention (Technical Field)

The present invention relates to deposition of material on a target using the LENS® process, which allows complex three-dimensional geometric structures to be fabricated efficiently in small lots to meet stringent requirements of a rapidly changing manufacturing environment. More particularly, the invention pertains to the fabrication of three-dimensional metal parts directly from a computer-aided design (CAD) electronic “solid” model. The invention addresses methods to direct material deposition processes to achieve a net-shaped or near net-shaped article with unsupported overhangs and angles. The material may be deposited at high angles to the target normal, thus increasing the achievable overhang. Different flow nozzle designs are described for this purpose. The present invention also relates to the deposition of sacrificial structures to temporarily support overhanging elements, and other improvements to the LENS® process.

2. Background Art

Note that the following discussion refers to a number of publications and references. Discussion of such publications herein is given for more complete background of the scientific principles and is not to be construed as an admission that such publications are prior art for patentability determination purposes.

Manufacturing techniques or technologies generally known as “layered manufacturing” have emerged over the last decade. For metals, the usual shaping process forms a part by removing metal from a solid bar or ingot until the final shape is achieved. With the new technique, parts are made by building them up on a layer-by-layer basis. This is essentially the reverse of conventional machining. In a paper entitled “An Overview of Rapid Prototyping Technologies In Manufacturing” by Dr. A. Dolenc, 1994, appearing at the Internet site of Helsinki University of Technology (and also at http://swhite.me.washington.edu/˜ganter/me480/rp.pdf), the first commercial process was presented in 1987. The process then was very inaccurate, and the choice of materials was limited. The parts were considered, therefore, prototypes and the process was called rapid prototyping technology (RPT). The prior art has advanced, however, to a point where it has been favorably compared to conventionally numerically controlled (NC) milling techniques. Considerable savings in time, and therefore cost, have been achieved over conventional machining methods. Moreover, there is a potential for making very complex parts of solid, hollow, or latticed construction.

Stereolithography technique (SLT), sometimes known as solid freeform fabrication (SFF), is one example of several techniques used to fabricate three-dimensional objects. This process is described in the Helsinki University of Technology paper. A support platform, capable of moving up and down is located at a distance below the surface of a liquid photo polymer. The distance is equal to the thickness of a first layer of a part to be fabricated. A laser is focused on the surface of the liquid and scanned over the surface following the contours of a slice taken through a model of the part. When exposed to the laser beam, the photo polymer solidifies or is cured. The platform is moved downwards the distance of another slice thickness and a subsequent layer is produced analogously. The steps are repeated until the layers, which bind to each other, form the desired object. A He—Cd laser may be used to cure the liquid polymer. The paper also describes a process of “selective laser sintering.” Instead of a liquid polymer, powders of different materials are spread over a platform by a roller. A laser sinters selected areas causing the particles to melt and solidify. In sintering, there are two phase transitions, unlike the liquid polymer technique in which the material undergoes but one phase transition: from solid to liquid and again to solid. Materials used in this process include plastics, wax metals and coated ceramics.

However, these technologies are limited in their applications of overhangs and angles in fabricated articles. U.S. Pat. No. 5,038,014, issued on Aug. 6, 1991 to Vanon D. Pratt, et al., entitled “Fabrication of Components by Layered Deposition”, discloses a powder nozzle angle preferably in the range of 35-60 degrees, and most preferably in the range of about 40-55 degrees. Pratt further teaches that an angle of greater than about 60 degrees makes it difficult for the nozzle and powder to avoid premature interaction with the laser beam, and less than about 35 degrees makes it difficult to deliver the powder concurrently with the laser beam at the spot desired on the article surface. Using these angles, Pratt discloses forming overhangs by melting a powder material with a laser beam and depositing the molten material to form successive layers in patterns of corresponding cross sections of the article, at least one of the successive cross sections partially overlying the underlying cross section and partially offset from the underlying cross section, so that a layer deposited in at least one of the cross sections is partially unsupported by the previously deposited material, thus forming an overhang. However, such overhangs are of minimal application in the industry.

U.S. Pat. No. 6,410,105, issued on Jun. 25, 2002 to J. Mazumder, et al., entitled “Production of Overhang, Undercut, and Cavity Structures Using Direct Metal Deposition”, discloses another method of creating overhangs using a rapid prototyping technology. Overhang features are fabricated through the selective deposition of a lower melting point sacrificial material using a laser-aided direct-metal deposition process. Following the integrated deposition of both sacrificial and non-sacrificial materials, the part is soaked in a furnace at a temperature sufficiently high to melt out the sacrificial material. As preferred options, the heating is performed in an inert gas environment to minimize oxidation, with a gas spray also being used to blow out remaining deposits. While the end result is an overhang, the process requires many steps and is not time efficient.

The problem of providing a method and apparatus for unsupported overhangs and angles in fabricating articles having a fully dense, complex shape, made from gradient or compound materials from a CAD solid model, is a major challenge to the manufacturing industry. Creating complex objects with desirable material properties and shapes, cheaply, accurately and rapidly has been a continuing problem for designers. Producing such objects in high-strength stainless steel and nickel-based super alloys, tool steels, copper and titanium has been even more difficult and costly. Having the ability to use qualified materials with significantly increased strength and ductility will provide manufacturers with exciting opportunities. Solving these problems would constitute a major technological advance and would satisfy a long felt need in commercial manufacturing, especially in the medical field.

### SUMMARY OF THE INVENTION (DISCLOSURE OF THE INVENTION)

The present invention is an apparatus for depositing material on a target, the apparatus comprising a laser beam from processing the material on the target and one or more nozzles disposed around the laser beam for propelling to the target a powder comprising the material mixed with a gas, wherein at least one of the nozzles comprises an angle of powder entry greater than approximately 28°. At least one of the nozzles preferably comprises an angle of powder entry greater than approximately 60°, or optionally an angle of powder entry of approximately 90°, or optionally an angle of powder entry between approximately 90° and approximately 180°. The nozzles optionally comprise different angles of powder entry. The nozzles preferably are evenly spaced around the laser beam. The apparatus is preferably capable of building an overhang on any side of the target. The powder flow through each of the nozzles is preferably independently controllable. The nozzles are preferably aimed at a point comprising the focus of the laser beam on the target. Each nozzle preferably comprises an adjustable angle of powder entry. The gas preferably comprises an inert gas.

The nozzles preferably comprise orifices in an annular ring. The ring preferably comprises twelve nozzles and is preferably removable. A first annular ring preferably comprises nozzles which comprise a first angle of powder entry, and the angle of powder entry is varied preferably by replacing the first annular ring with a second annular ring comprising nozzles which comprise a second angle of powder entry. Alternatively, the nozzles can be individual and are preferably replaceable. The apparatus preferably further comprises a purge nozzle or a purge line. The nozzles preferably direct powder entry into a melt pool formed by the laser on the target. The nozzles are preferably translatable with respect to the target along at least one linear axis and preferably rotatable with respect to the target about at least one rotational axis.

The present invention is also an apparatus for propelling powder at a target, the apparatus comprising an annular ring, a flow passage within the annular ring, one or more ports for providing powder and gas flow to the flow passage, and one or more nozzles for directing the powder from the flow passage to the target. The nozzles are preferably spaced at even intervals around the ring. There are preferably twelve nozzles. At least one of the nozzles is preferably oriented at an angle of at least approximately 28°, or optionally at least approximately 60°, or optionally equal to approximately 90° with respect to the central axis of the annular ring.

The present invention is also a method of building an overhang on a target, the method comprising the steps of propelling powder to the target, processing the powder to form a first material in a first region of the target with a laser beam having a first energy density; processing the powder to form a second material in a second region of the target with a laser beam having a second energy density, the second region at least partially overlaying the first region; and removing the first material. The removing step is preferably performed using a method selected from the group consisting of impacting, grit blasting, and abrading. The first material is preferably removable without causing damage to the second material and preferably comprises a strength no more than approximately that which is required to support the second material during the step of processing the powder to form a second material. The first energy density is preferably less than or equal to approximately 50% of the second energy density. The method preferably further comprises the step of initially processing the powder in the first region of the target with a laser beam having an initial energy density, the initial processing occurring until the powder begins to adhere. The initial energy density is preferably approximately 70% of the second energy density.

The invention is also a method of forming an overhang, the method comprising the steps of providing a laser beam, disposing one or more nozzles having an angle of powder entry greater than 28° around the laser beam, propelling powder from at least one of the nozzles toward a target, and processing the powder propelled from the at least one nozzle with the laser beam in order to form an overhang on a structure. At least one of the nozzles preferably comprises an angle of powder entry greater than approximately 60°, or optionally equal to approximately 90°. The processing step preferably comprises forming a melt pool of the powder with the laser beam. The method preferably further comprises the step of aiming the nozzles at a point where the laser beam contacts the melt pool. The powder is preferably propelled into the melt pool at the angle of powder entry of the at least one nozzle. The melt pool preferably grows at approximately the angle of powder entry relative to a main body of the structure. At least a portion of the overhang preferably comprises the angle of powder entry of the at least one nozzle.

The overhang is preferably formed layer by layer. The nozzles are preferably evenly spaced around the laser beam. The method optionally further comprises the step of adjusting the angle of powder entry of each nozzle. The method preferably further comprising the step of independently controlling the flow of powder through each nozzle. The disposing step preferably comprises disposing an annular ring comprising the nozzles around the laser beam, and the nozzles preferably comprise the same angle of powder entry. The method preferably further comprises the step of changing the angle of powder entry by replacing the annular ring with a second annular ring comprising nozzles comprising a second angle of powder entry. Alternatively, the method further comprising the step of replacing the annular ring with a nozzle housing comprising individual nozzles, and preferably further comprises the step of replacing one or more of the individual nozzles. The method preferably further comprises the step of propelling powder to the target using one or more discrete nozzles arranged around the nozzles. The discrete nozzles each preferably comprise an angle of powder entry between0 and approximately 180°. The method preferably further comprises either or both of the steps of translating the nozzles relative to the structure along at least one linear axis or rotating the nozzles relative to the structure along at least one rotational axis.

An object of the present invention is to provide a method and apparatus for manufacturing unsupported overhang structures with angles ranging from approximately 0 to 180°, preferably fabricated from CAD models.

Another object of the present invention is to provide a method for depositing weak removable material used to support such overhang structures and subsequently removing such material.

An advantage of the present invention is that powder impinging on the surface of the melt pool can collect more easily due to the greater angles of powder entry.

Another advantage of the present invention is that an annular ring, a multiple nozzle housing assembly, and the additional discrete nozzles can all be used on the same system.

Yet another advantage of the present invention is that overhangs can be fabricated on any side of (i.e. 360° around) a part.

A further advantage of the present invention is that due to the greater angle, complex geometries with overhangs up to approximately 180° can be fabricated in a single step using a LENS® system, such as those required for specialized manifolds or hip replacement parts or other medical implants.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 reveals a side-view schematic of a method of manufacturing overhanging structures using 3-axis positioning of the deposition head in respect of the work piece.

FIG. 2 is a closer look at view B of FIG. 1, showing how surface tension aids in maintaining the deposited material bead at the edge of a part.

FIG. 2a is another look at view B of FIG. 1 illustrating how additional beads of material may be attached to an existing overhanging surface. Additional deposition contours are added serially and Δx is kept small with respect to the bead diameter.

FIG. 3 shows a method of making an overhanging structure by rotating the work piece relatively in respect of the deposition head so the focused laser beam is parallel to a tangent to the surface being built. The deposition head can be rotated in multiple axes to implement the relative movement.

FIG. 4 is an enlarged view C of FIG. 3 showing the relationship of the laser beam-powder interaction area to the edge of the part that is being built.

FIG. 5 is a side-view schematic of the work piece which is the target of the deposition, showing previously deposited material beads at the edges of the layer to be constructed which act as dams to contain fill material.

FIG. 6 is a side-view schematic of the deposition head using a standard fill process for filling in the deposition layer behind material beads that have been placed at the edges as dams, as depicted in FIG. 5.

FIG. 7 is a schematic showing a preferred embodiment of the LENS® deposition head with the annular ring attached.

FIG. 8 is a cross-sectional schematic showing the multiple orifices surrounding the annular ring.

FIG. 9 is a cross-sectional schematic showing the direction of the powder through the annular ring.

FIG. 10a is a cross sectional schematic showing an alternative embodiment using a multiple nozzle deposition head.

FIG. 10b is a schematic showing an alternative embodiment using a multiple nozzle deposition head.

FIG. 11 is a schematic showing another alternative embodiment using additional discrete nozzles and illustrating an overhang.

FIGS. 12 to 16 are side and front elevations and perspective views of a multi-axis deposition head. The head includes an integral powder delivery system.

FIG. 16a presents a perspective view of the multi-axis deposition head, illustrating deposition of three-dimensional structure having a curved surface. In this example, the head is positioned in three translational and two rotational axes.

### DESCRIPTION OF THE PREFERRED EMBODIMENTS

### BEST MODES FOR CARRYING OUT THE INVENTION

The LENS® system dispenses metals in patterns preferably dictated by three-dimensional CAD models. Guided by these computerized blueprints, the system creates material structures by depositing them, preferably one layer at a time. The system preferably uses a laser, such as a high-powered Nd:YAG laser, to strike a target and produce a preferably molten pool. Through a deposition head, a nozzle then preferably propels a precise amount of powdered metal into the pool to increase the material volume. A layer is built to the CAD geometric specifications as the positioning system moves the target under the laser beam in the X-Y plane. The lasing and powder-deposition process repeats until the layer is complete. The LENS® system then refocuses the laser in the Z direction, normal to the target, until the unit builds layer upon layer and completes the material version of the CAD model. The standard mode of operation includes 2.5 axes of motion, computer control, a controlled atmosphere chamber, one laser beam, a standard powder deposition head with a primary powder line, and a target.

Parts or other depositions which are produced according to the LENS® method often incorporate overhangs, defined as any deposited structure, edge, area, or portion of a deposited structure, which extends laterally from an existing structure without substantial support underneath it. Overhangs may occur in cavities within a structure. The purpose of the present invention is to increase the overhang angle to any part that can be built using a LENS® system in its standard mode of operation. Overhangs may be deposited using typical nozzle(s), or alternatively using the greater-angle nozzles described herein. The latter have the capability of depositing directly onto the side of a previously deposited structure, often producing an overhang. An additional advantage to using nozzles with a greater angle of powder entry when creating an overhanging surface, or during freeform fabrication, is that the powder impinging on the surface may collect more easily than powder from standard, lower angle nozzles, thus facilitating the construction of the overhang.

The present invention also is a deposition process that uses more than three axes of motion such that the part build axis can be varied during the process to allow unsupported overhangs or overhanging edges to be built. In an alternative deposition process, the additional axes of motion may be used to fabricate outer surfaces that are unsupported by directing the deposition beam such that it is substantially tangent to the overhang surface. In one embodiment of the invention, these additional axes of motion are provided by a multi-axes deposition head 480. Movement of the deposition head in multiple axes, for example up to five axes, offers advantages of flexibility over the conventional x-y plane positioning, for producing overhangs and other shapes.

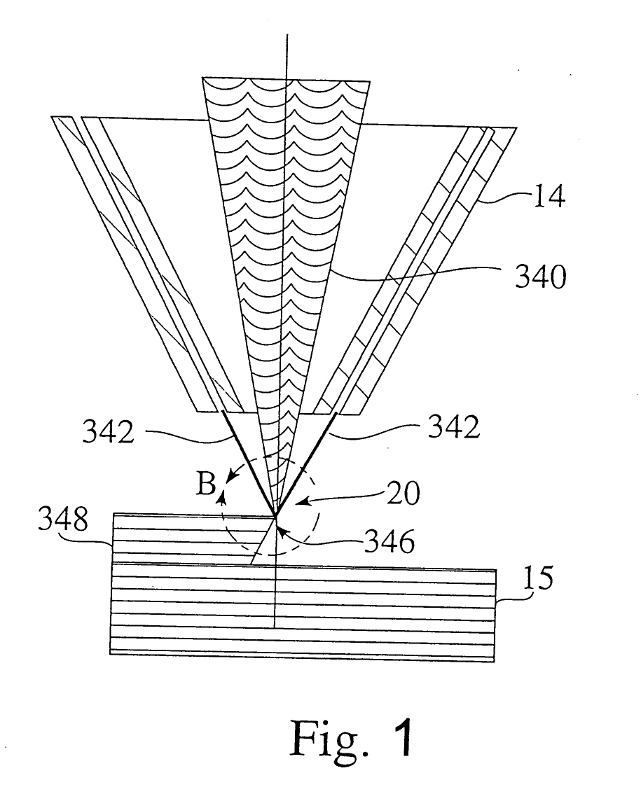

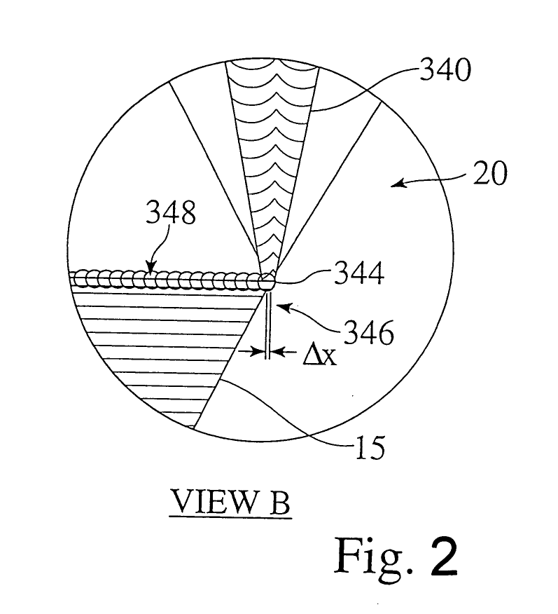

FIGS. 1 and 2 illustrate one preferred method of producing an unsupported overhang 346 in a structure 15 using three-axis positioning. The focused laser beam 340 is moved a distance Δx over the edge of a previously deposited surface 15 and a bead of material 344 is deposited. The distance Δx is typically less than ½ of the focused laser beam diameter 17. At the distance Δx, surface tension of the melted material 342 aids in maintaining the edge, thus allowing a slight overhang 346. By repeating this deposition several times in one layer 348, an angle of the overhang 346 of approximately 60 degrees can be achieved. After the overhanging edge 346 bead 344 and other edge beads 344 are deposited, material is filled in to complete the layer 348.

FIG. 2a shows how additional beads of material may be attached to an existing overhanging surface 346. By defining the overhanging surface 346 as a series of contours that incrementally move outward, away from a solid structure 15, several beads 345 of material may be added to a structure to extend the build over an unsupported region. A second bead of material 345 is deposited to the first edge bead 344 using a multiple contouring method. The overhanging surface is extended into a region where there is no underlying support for the bead. The method provides a “virtual” support for the overhanging build.

In an alternative embodiment, the multi-axis capability of the invention is used to deposit the overhanging surfaces 344, and then the filled regions are filled 348 by the deposition beam, which is directed towards the build surface in a direction normal to the target surface.

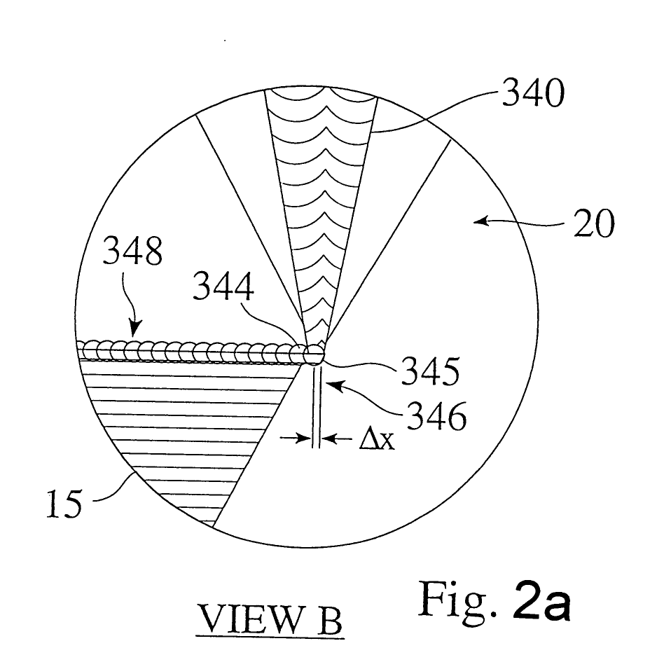

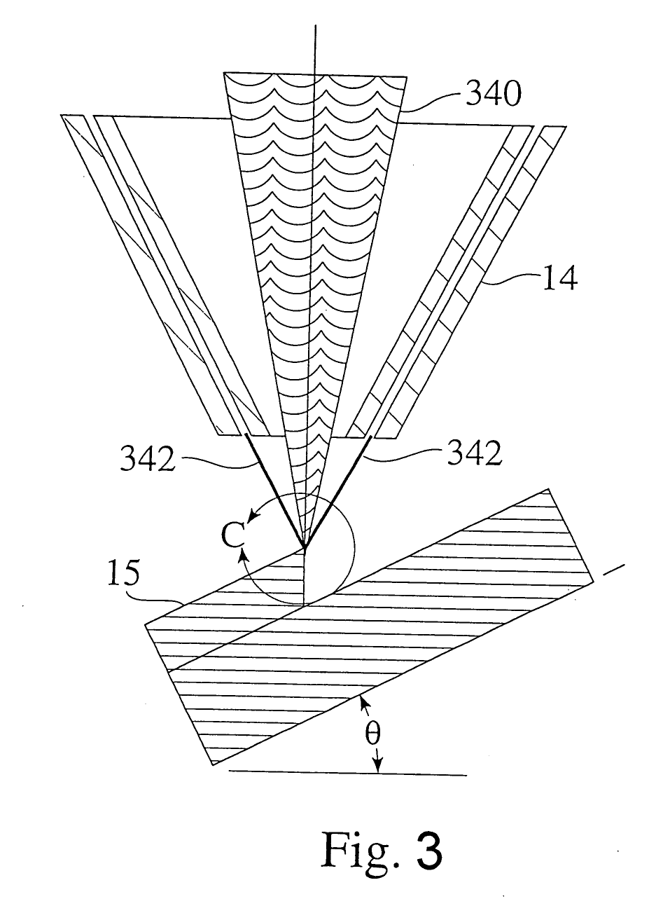

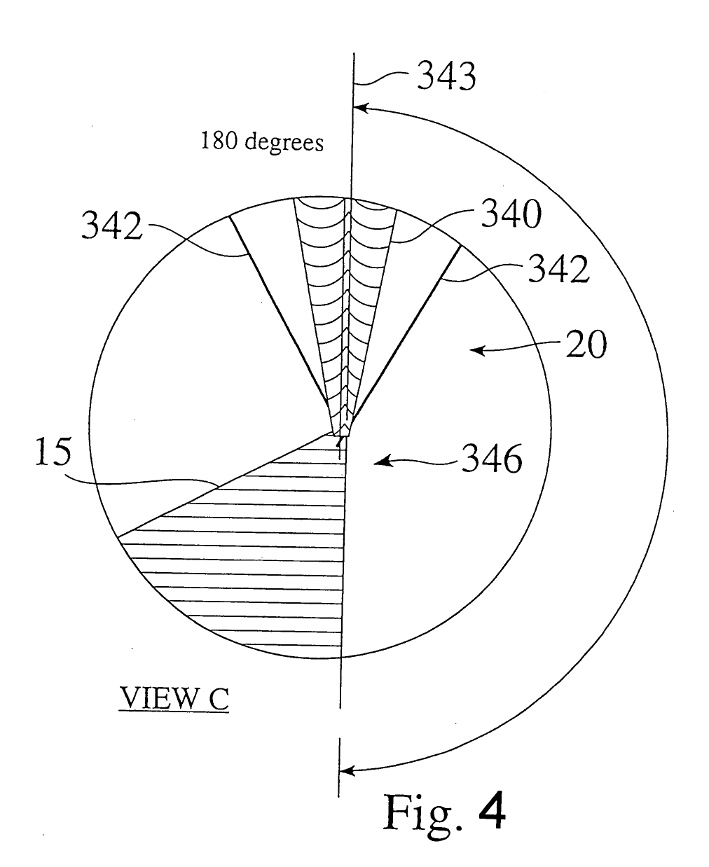

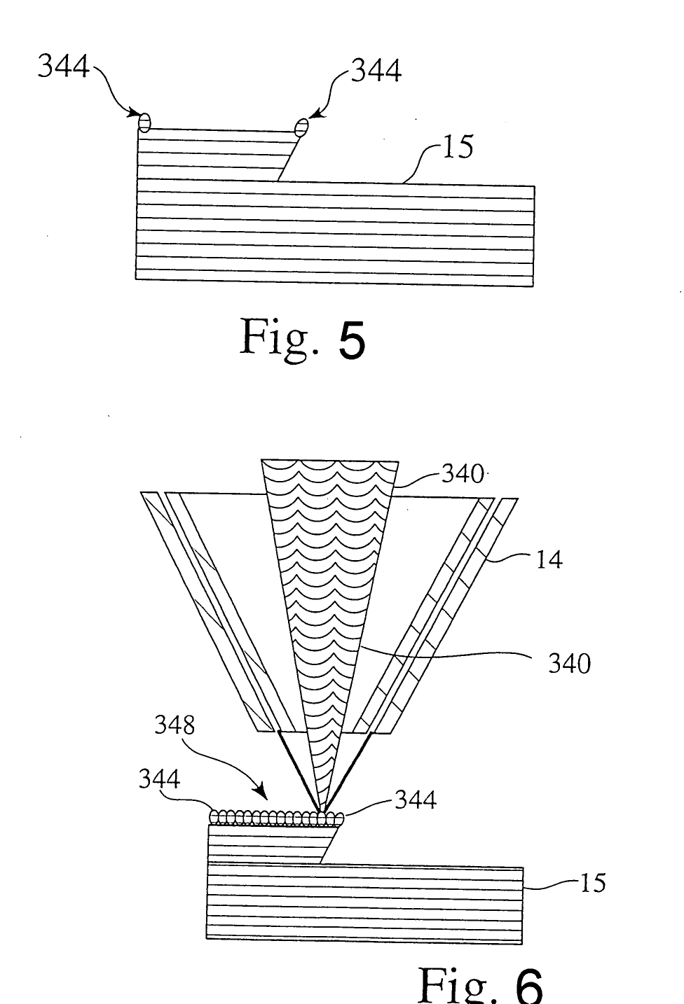

In another alternative embodiment, the plane of deposition is rotated in respect of the work piece 15 as shown in FIGS. 3 and 4 so the focused laser beam 340 is parallel to a tangent 343 to the surface which is being built. When the edge beads 344 have been deposited as in FIG. 5, the part can be reoriented with the deposition layer 348 normal to the laser beam 340 axis as seen in FIG. 6. The layer 348 is filled in, as before.

Note that either the part 15 or the laser deposition head 14 can be adjusted to accomplish parallelism of the laser beam 340 axis with the tangent 343 to the surface of the deposition 15. In fabricating certain configurations of structures, it is easier to tilt and rotate the deposition head axes than those of the part. The present invention, therefore, includes a deposition head which deposits materials in directions other than downward along the z-axis.

In a standard LENS® deposition head, the angle of the nozzle, which propels powder into the process, is approximately 28° to the laser beam (i.e., the angle of powder entry). The laser beam is preferably vertical, but can be at any angle relative to the target. This angle is optimal for many applications. However, by increasing this angle, the degree of overhang that is achievable is increased. The overhang is determined by the surface tension of the material, the speed of deposition, etc., and is typically approximately 15° or less when using the original nozzle angle. Increasing the angle of powder entry from 28° to approximately 60°, approximately 75°, approximately 90°, or even up to approximately 180°, results in the creation of an unsupported overhang having up to the equivalent angle, since the overhang angle at which the molten pool will grow out from the main body of the build is determined by the angle at which the powder stream enters the melt pool (i.e. the angle of powder entry). Thus, material may be added to the side of an existing structure to more easily manufacture a desired part.

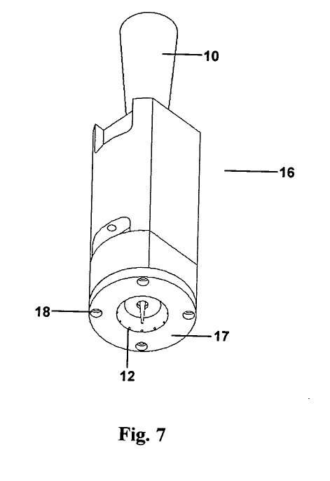

A preferred deposition head for depositing overhangs or for producing other greater angle deposits is shown in FIG. 7. Deposition head 16 comprises annular ring 17, which preferably comprises multiple orifices or nozzles 12 spaced around the ring, preferably at even intervals. Although twelve nozzles are preferable, any number may be used. Annular ring 17 is attached to the deposition head 16 preferably by four bolts disposed in slots 18. The orifices thereby preferably surround laser beam 10 and thus the target or build, and are preferably angled inward so that each orifice directs its powder stream as desired into the melt pool created by the focused beam. The orifices may all be at the same angle of powder entry, or at different angles.

By using an annular ring of nozzles that surround the build, overhangs may be built on all sides of, or 360° around, a part. The nozzles in the annular ring are preferably placed in the range of 0° to 90° to the beam incidence with the build target. The powder delivery angle preferably ranges from 0° to 90°. The powder delivery angle functions to direct powder entry into the melt pool; thus, the angle of the nozzles determines the angle that the powder stream enters the melt pool. By injecting powder from the annular ring nozzles, it is possible to build overhangs of up to 90°. Injecting powder into the molten pool created by the laser beam at 90° will cause the molten pool to grow at approximately 90° to the main body of the build.

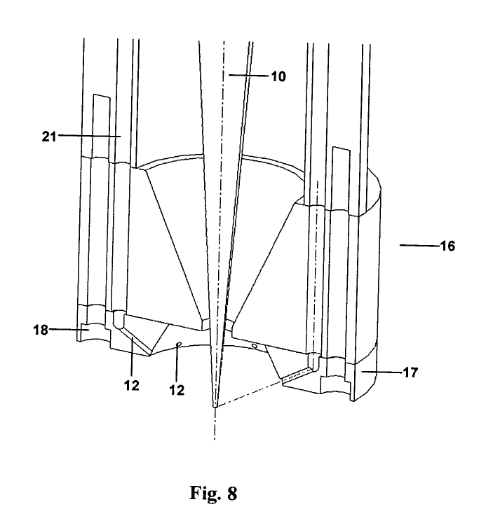

FIG. 8 shows a cross-sectional schematic of the annular ring attached to the deposition head. Deposition head 16 and annular ring 17 preferably comprise a conical center passage through which laser beam 10 travels towards the target. A primary powder line preferably supplies powder to the annular ring nozzles 12, preferably through four ports. It is preferable that the gas comprises an inert gas, such as argon. The powder and gas stream enters annular ring 17 through the ports and is directed into flow passages 21, which then direct the powder and gas stream to each nozzle 12. Alternatively, a subset of nozzles 21 may be fed from one or more plenum chambers into which powder is delivered. Each plenum chamber may optionally feed adjacent nozzles, or alternatively nozzles with the same angle of powder entry, or both. The powder may alternatively be introduced into the head via individual lines which feed each orifice, in which case the powder amount flowing through each orifice may optionally be separately controllable.

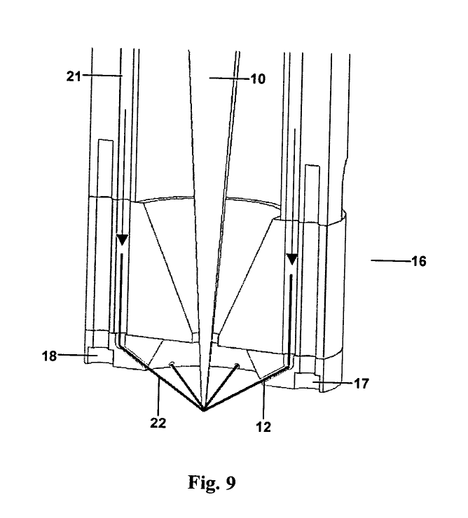

Nozzles 12 are preferably oriented so as to coincide at a common point that is also coincident with the focus of laser beam 10. Nozzles 12 can be positioned all at the same angle or at differing angles. This may be achieved by removing annular ring 17 and attaching a new ring comprising nozzles at different angles, or by having a single annular ring with adjustable-angle nozzles. Nozzles 12 then direct powder entry into a melt pool on the target. This allows for building any angle or overhang on all sides of a deposited part, with angles ranging from 0° to 90°. FIG. 9 shows the powder and gas flowing through deposition head 16 and annular ring 17.

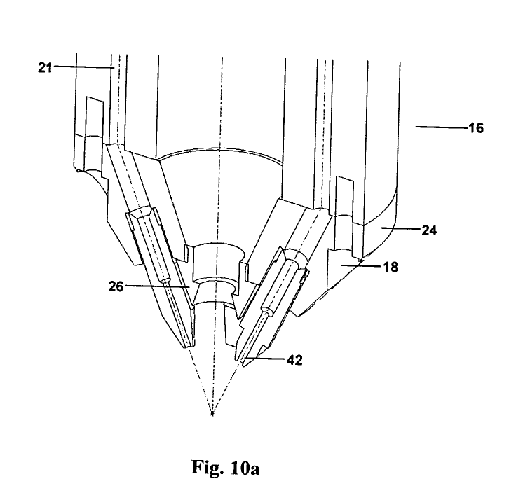

FIGS. 10a and 10b show a second preferred embodiment of the present invention. The annular ring of the previous embodiment is replaced with nozzle housing 24 that is attached to deposition head 16 preferably using bolts disposed in slots 18. The nozzle housing 24 preferably houses four nozzles 42 and center purge nozzle 26, although any number of nozzles 42 may be used. Center purge nozzle 26 blows gas into the deposition area in order to keep powder from bouncing back up onto the focusing lens of the laser beam. This prevents damage to the focusing lens and also helps to keep the lens clean. Nozzles 42, like those in the annular ring, are preferably fed using a flow passage and are preferably individually replaceable. Nozzles 42 may comprise fixed or adjustable angles of powder entry. The nozzles direct powder into the melt pool within a preferred range of 0° to 90° to the beam incidence with the build target, producing results similar to those of the annular ring. It is preferable that nozzle housing 24 be interchangeable with the annular ring of the previous embodiment (that is, they are mountable to and integrated with deposition head 16 in the same manner), so the user can easily switch between them depending on the application.

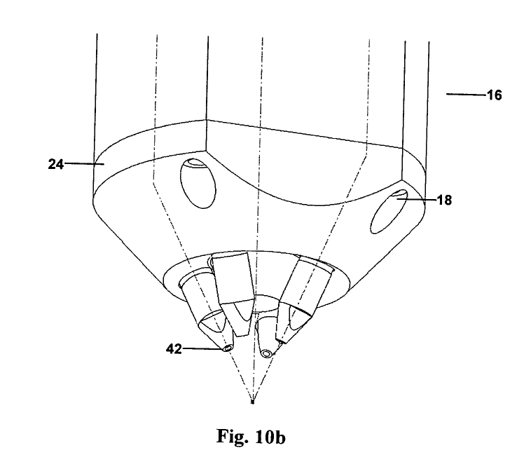

FIG. 11 shows another alternative embodiment of the present invention. One or more discrete nozzles 30 are fed powder, preferably via a tee from main powder line 46. Preferably four nozzles are equally spaced around deposition head 16, although any number of nozzles may be used. After the tee, the powder passes through discrete powder lines 28 or optional second powder deposition head to be distributed to discrete nozzles 30. Valve 44, which can be manually, electronically, or automatically operated, is preferably placed on each discrete powder line 28 to control the powder amount exiting the corresponding discrete nozzle. This allows for building any angle or overhang on the side of the part where an active discrete nozzle is located. This configuration also allows each discrete nozzle 30 to be individually and independently controlled if desired; for example, one nozzle may be used while the others are turned off. Of course, any other such combination may be used as desired. If a center purge nozzle is not present in deposition head 16, separate center purge line 32 is used for the gas flow. The discrete nozzles of this embodiment may be used in addition to, or instead of, the nozzles in the deposition heads of the previous embodiments.

FIG. 11 also illustrates an overhang 38 being built from the main body 36 of the build on a target 34. FIG. 11 depicts discrete nozzles 30 at approximately 70° to the laser beam; however, the nozzle can be at an angle of powder entry ranging from 0° to approximately 180°. As in the previous embodiments, the angle of powder entry determines at which angle the molten pool grows relative to the main body of the build or deposited structure. If it were shown in FIG. 11, a nozzle having an angle of powder entry of 90° would be approximately horizontal. Similarly, a nozzle having an angle of powder entry of 90° would be approximately vertical, aiming upward. Discrete nozzles 30 preferably comprise copper.

Any of the nozzle or head configurations of the present invention may be used in conjunction with a multi-axis deposition head, which preferably comprises the powder delivery system and optical fiber or other laser beam delivery system and is moveable about a plurality of translational and rotational axes. The direction of the powder stream in the deposition process is preferably coordinated with a control computer in a plurality of coordinate axes (x, y, z, u, v).

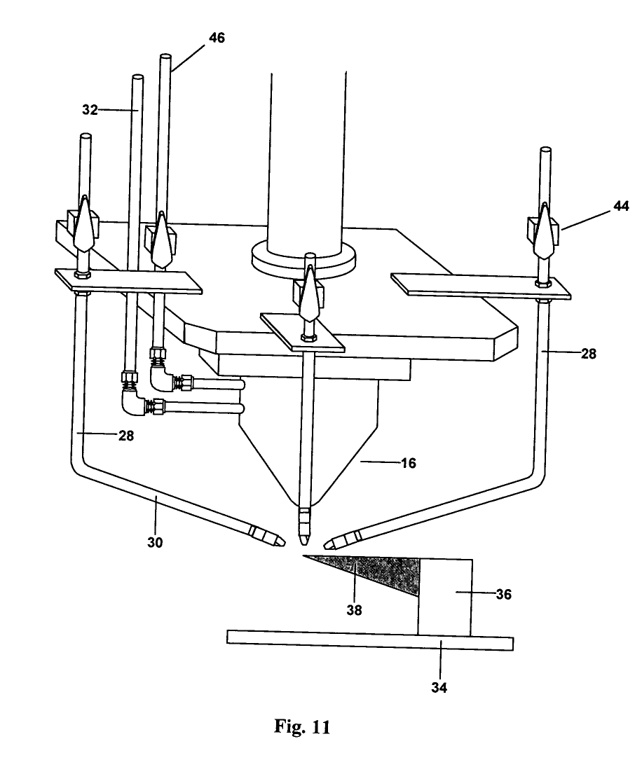

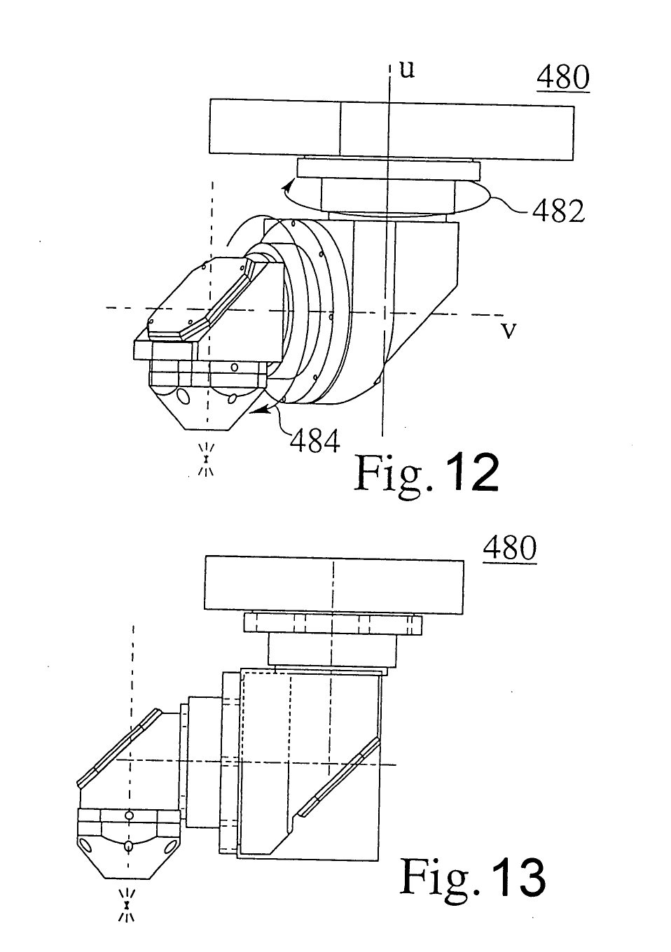

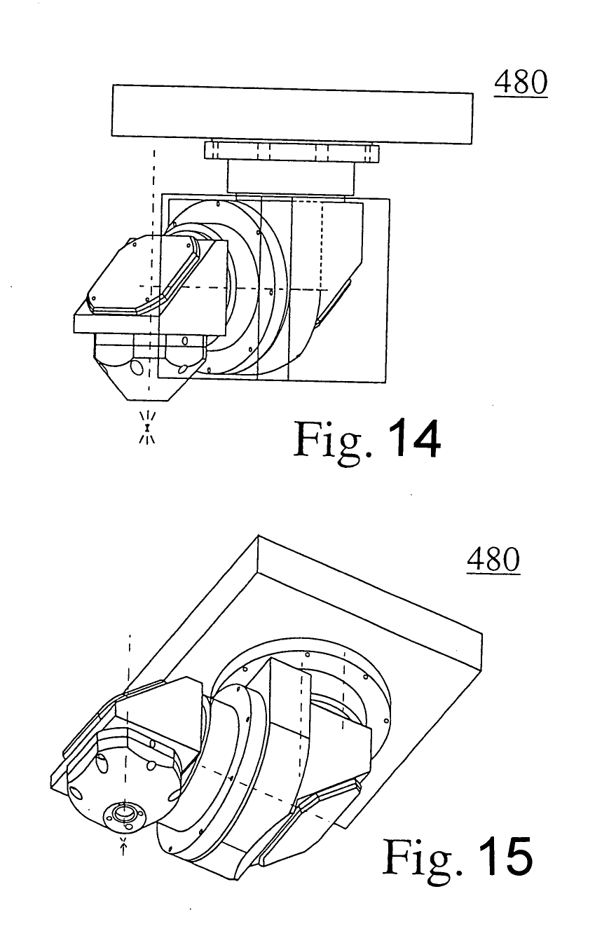

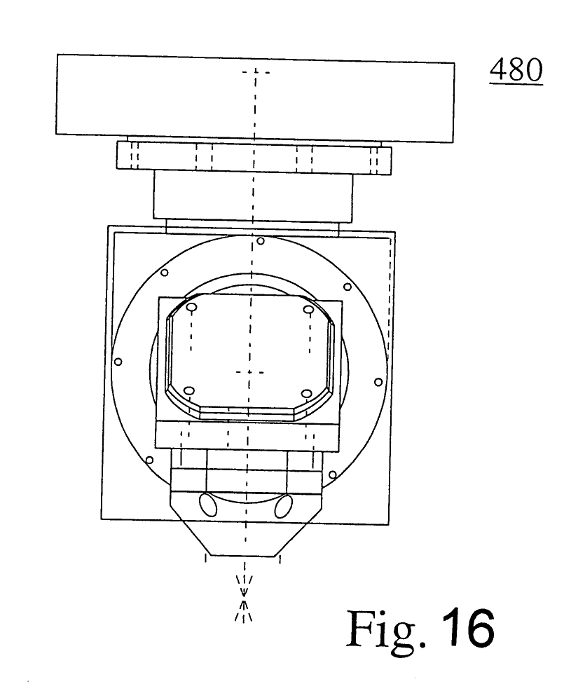

FIGS. 12 through 16a reveal a multi-axis deposition head 480 which is designed to deposit materials in directions in addition to the z-axis. The head 480 contains the powder delivery system integrally. When coupled with a three-axis stage which positions the deposition head 480 in the x-y-z orthogonal axes, the deposition head 480 provides rotation 482 about a fourth axis u and rotation 484 about a fifth axis v. Of course, the work piece can also be moved in the x-y-z orthogonal axes and the deposition head 480 held stationary.

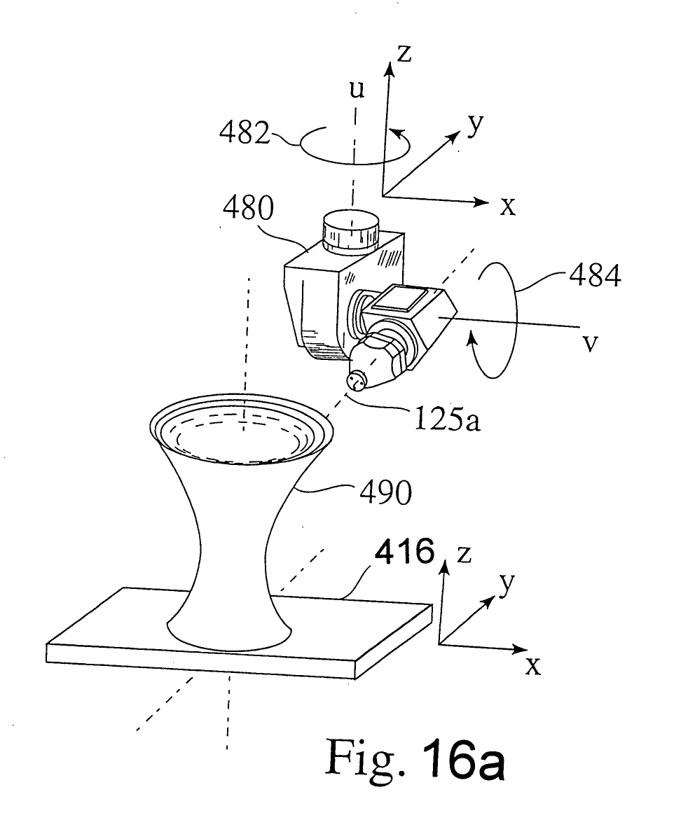

FIG. 16a shows how the deposition head 480 is continually positioned to produce a three-dimensional, curved object 490. It is the relative motion of the deposition head 480 and the work piece which creates the lines of material deposition, as has already been seen. Applying the multi-axis feature of the deposition head 480 enables three-dimensional structures of virtually every kind to be fabricated directly from a CAD solid model. In addition to the multi-axis head 480, robotic arms and tilting, rotating stages for the work piece are usable for fabrication of many three-dimensional structures. These features also facilitate use of transformations to various coordinate systems which accommodate specific geometric configurations such as cylinders and spheres.

The multi-axis deposition head 480 includes the powder delivery system 170 and optical fiber laser beam delivery system 420 described in commonly owned U.S. Pat. No. 6,811,744. FIG. 16a illustrates how the multi-axis deposition head 480 is positioned in order to produce a three dimensional, curved structure 490. Controlled translation in three axes x, y and z and controlled rotation about two axes u and v are used to position the deposition head 480 with respect to the work piece 490. Note that the translation of the head in the x, y and z axes can be used in place of or in combination with the translation of stage 416.

For some parts or materials, as an overhang is being deposited (preferably via one of the embodiments of the present invention), forces such as gravity may cause it to sag or collapse, or the overhang angle may be too great to enable a build to be made. Thus the overhang may need to be temporarily supported until it is fully deposited, and optionally until the completion of processing, which ensures that the overhang is fully rigidized and integrated with the rest of the structure. However, the support must be completely removable, without damaging or necessitating the modification of the overhang or any other portion of the deposited part.

In general, if less energy is put into the process than is required to melt the powder arriving at the melt pool, the build tends to be porous, loosely bound, brittle, and having poor bonding and mechanical properties. However, by proper choice of the processing conditions, the build can still maintain its proper shape. By changing processing conditions in different areas of the build, a shape can be deposited with sound material and weak material, preferably of the same composition to avoid contamination, in different areas. It is preferable but not required that there is minimal adherence of the weak material to the sound material or the target. The sound material can be built on top of the weak material, or vice versa. In the case where the sound material is built on top of the weak material, on completion of the build, the poor material under the sound material can be removed by various means, including impact with a hammer, grit blasting, abrasion etc. The sound material will be relatively impervious to such means and will thus remain, forming an overhang. For ease of removal, the weak material should preferably be just strong enough to maintain its structural integrity and support the overhanging sound material, but no stronger. Depositing the weak material at low temperatures is preferable to avoid sintering or melting the material, which would undesirably increase its strength once solidified.

For example, in order to deposit weak material, the energy density of the laser was reduced to approximately 70% of its original value (i.e., the energy used to deposit sound material). Once the particles began to adhere, the energy density was reduced to at or below approximately 50% of its original value. This resulted in production of overhang support regions which had the above characteristics.

The following are a number of specific applications of the LENS® process.

Coatings

Titanium carbide is a material that is hard, and compatible with titanium metal. When melted into titanium, it precipitates out of solution to form a fine dispersion of titanium carbide particles. These particles increase the hardness of titanium, and thus improve the wear resistance of titanium, which is generally regarded as having poor wear properties. Titanium carbide, or other related compounds such as titanium boride, may be deposited using the LENS® process on the surface of a titanium part, rendering it more useful for medical devices, high performance automotive parts (e.g. gears), and other applications. By adjusting the deposition process parameters and materials, it is possible to adjust the wear hardness of the coating.

Similar advantages, such as improved wear resistance, may be obtained for cobalt chrome alloys such as F75 (commonly used in medical applications) by adding a chromium carbide surface coating.

The LENS® process produces a rough surface in the as-deposited state, typically with Ra of 100-500 μm. In certain medical applications, it is desirable to provide a surface that bone cells can grow into and thus attach to. Thus a medical device may be modified with a LENS®-deposited surface layer to provide roughness for bone ingrowth. Alternatively, the whole device may be manufactured using the LENS® process, with the surface left unfinished, or finished as desired, to allow for bone ingrowth.

Custom Implants

Medical implants, or replacements for bone structures, are ideally custom manufactured for each patient. Because the LENS® process can make every component individually, and uses a solid model to construct each part, it is an ideal process for this application. Preferably, X-ray, MRI, or other data is used to create a solid model of the component, and the LENS® process is used to build the component. The preferably finished component is then implanted. The part may optionally be subject to a Hot Isostatic Press (HIP) to eliminate defects in the material and ensure soundness.

Gas Preheating for Improved Cracking Resistance

Some materials are very hard to deposit by the LENS® process without cracking. The most common type of cracking is called solidification cracking. This occurs when the ductility of the material is lower than the strain that is put on the material by shrinking during cooling. Most metals shrink around 2% between their melting point and room temperature. If the ductility of the material is only, for example, 1%, it has to accommodate this strain some other way. Often the accommodation takes the form of bending the target or substrate on which the material is deposited, so the material doesn't have to shrink as much. Alternatively, the material may crack.

This situation can be mitigated by allowing the material to cool more slowly than normal, which gives more time for the strain to be accommodated. It is well known in the literature to pre-heat a part that is about to be welded or manufactured using the LENS® process. This pre-heating increases the ductility of the target (or substrate) and deposit, reduces the cooling rate, and reduces the mismatch between the deposit temperature and target or substrate temperature, and thus reduces the mismatch in thermal strain (i.e. minimizes the thermal shock). In the LENS® process, target heating has been utilized to accomplish this. However, for the most difficult materials this is not usable, since the LENS® process preferably blows a significant amount of cold gas over the molten pool (which gas preferably carries the powder into the process), which cools the process rapidly even if there is target heating applied.

Thus it is desirable in certain applications to preheat the gas that carries the powder into the process. The gas is flowed through a tube, preferably approximately 1 meter in length, which is preferably coiled inside a furnace and is plumbed to the usual LENS® deposition head. The gas is thus preheated, and the cooling rate lowered. This system has been shown to be successful in manufacturing crack-free parts using materials which had cracked when other methods, such as target heating, were used.

Nitrogen Removal

The LENS® machine preferably operates in an argon atmosphere with an oxygen gettering system that maintains the oxygen level typically below 10 ppm. If the gettering system is turned off, the oxygen level slowly climbs, by roughly 10 ppm per hour. Because the concentration of nitrogen in the air is four times that of oxygen, it is expected that, in the absence of a gettering system, the nitrogen level should increase at a rate approximately four times greater than that of oxygen, i.e. at 40 ppm/hr. As it might be weeks at a time between purging the LENS® system to renew the atmosphere, it is thus possible that the nitrogen level may become very high within a short time, and remain high. Many materials are sensitive to the presence of nitrogen, including titanium, nickel etc. Thus it is useful to add a nitrogen gettering system to a LENS® machine, to keep nitrogen levels below a desired concentration.

The preceding examples can be repeated with similar success by substituting the generically or specifically described reactants and/or operating conditions of this invention for those used in the preceding examples.

Although the present invention has been described in detail with reference to particular preferred and alternative embodiments, other embodiments can achieve the same results. Persons possessing ordinary skill in the art to which this invention pertains will appreciate that various modifications and enhancements may be made without departing from the spirit and scope of the invention. Variations and modifications of the present invention will be obvious to those skilled in the art and it is intended to cover all such modifications and equivalents. The various configurations that have been disclosed above are intended to educate the reader about preferred and alternative embodiments, and are not intended to constrain the limits of the invention. The entire disclosures of all patents and publications cited above are hereby incorporated by reference.

What is claimed is:

1. An apparatus for depositing material on a target, the apparatus comprising:
a laser beam from processing the material on the target; and
one or more nozzles disposed around said laser beam for propelling to the target a powder comprising the material mixed with a gas;
wherein at least one of said nozzles comprises an angle of powder entry greater than approximately 28°.

2. The apparatus of claim 1 wherein at least one of said nozzles comprises an angle of powder entry greater than approximately 60°.

3. The apparatus of claim 2 wherein at least one of said nozzles comprises an angle of powder entry of approximately 90°.

4. The apparatus of claim 2 wherein at least one of said nozzles comprises an angle of powder entry between approximately 90° and approximately 180°.

5. The apparatus of claim 1 wherein said nozzles comprise different angles of powder entry.

6. The apparatus of claim 1 wherein said nozzles are evenly spaced around said laser beam.

7. The apparatus of claim 1 capable of building an overhang on any side of the target.

8. The apparatus of claim 1 wherein a powder flow through each of said nozzles is independently controllable.

9. The apparatus of claim 1 wherein said nozzles are aimed at a point comprising the focus of said laser beam on the target.

10. The apparatus of claim 1 wherein each nozzle comprises an adjustable angle of powder entry.

11. The apparatus of claim 1 wherein the gas comprises an inert gas.

12. The apparatus of claim 1 wherein said nozzles comprise orifices in an annular ring.

13. The apparatus of claim 12 wherein said annular ring comprises twelve nozzles.

14. The apparatus of claim 12 wherein said annular ring is removable.

15. The apparatus of claim 14 wherein a first annular ring comprises nozzles which comprise a first angle of powder entry.

16. The apparatus of claim 15 wherein an angle of powder entry is varied by replacing said first annular ring with a second annular ring comprising nozzles which comprise a second angle of powder entry.

17. The apparatus of claim 1 wherein said nozzles are replaceable.

18. The apparatus of claim 1 further comprising a purge nozzle or a purge line.

19. The apparatus of claim 1 wherein the nozzles direct powder entry into a melt pool formed by said laser on the target.

20. The apparatus of claim 1 wherein said nozzles are translatable with respect to the target along at least one linear axis.

21. The apparatus of claim 1 wherein said nozzles are rotatable with respect to the target about at least one rotational axis.

22. An apparatus for propelling powder at a target, the apparatus comprising:
an annular ring;
a flow passage within said annular ring;
one or more ports for providing powder and gas flow to said flow passage; and
one or more nozzles for directing said powder from the flow passage to the target.

23. The apparatus of claim 22 wherein said nozzles are spaced at even intervals around the ring.

24. The apparatus of claim 22 comprising twelve nozzles.

25. The apparatus of claim 22 wherein at least one of said nozzles is oriented at an angle of at least approximately 28° with respect to the central axis of said annular ring.

26. The apparatus of claim 25 wherein at least one of said nozzles is oriented at an angle of at least approximately 60° with respect to the central axis of said annular ring.

27. The apparatus of claim 26 wherein at least one of said nozzles is oriented at an angle of approximately 90° with respect to the central axis of said annular ring.

28. A method of building an overhang on a target, the method comprising the steps of:
propelling powder to the target;
processing the powder to form a first material in a first region of the target with a laser beam having a first energy density;
processing the powder to form a second material in a second region of the target with a laser beam having a second energy density, the second region at least partially overlaying the first region; and
removing the first material.

29. The method of claim 28 wherein the removing step is performed using a method selected from the group consisting of impacting, grit blasting, and abrading.

30. The method of claim 28 wherein the first material is removable without causing damage to the second material.

31. The method of claim 28 wherein the first material comprises a strength no more than approximately that which is required to support the second material during the step of processing the powder to form a second material.

32. The method of claim 28 wherein the first energy density is less than or equal to approximately 50% of the second energy density.

33. The method of claim 28 further comprising the step of initially processing the powder in the first region of the target with a laser beam having an initial energy density, the initial processing occurring until the powder begins to adhere.

34. The method of claim 33 wherein the initial energy density is approximately 70% of the second energy density.

35. A method of forming an overhang, the method comprising the steps of:
providing a laser beam;
disposing one or more nozzles having an angle of powder entry greater than 28° around the laser beam;
propelling powder from at least one of the nozzles toward a target; and
processing the powder propelled from the at least one nozzle with the laser beam in order to form an overhang on a structure.

36. The method of claim 35 wherein at least one of the nozzles comprises an angle of powder entry greater than approximately 60°.

37. The method of claim 36 wherein at least one of the nozzles comprises an angle of powder entry of approximately 90°.

38. The method of claim 35 wherein the processing step comprises forming a melt pool of the powder with the laser beam.

39. The method of claim 38 further comprising the step of aiming the nozzles at a point where the laser beam contacts the melt pool.

40. The method of claim 38 wherein the powder is propelled into the melt pool at the angle of powder entry of the at least one nozzle.

41. The method of claim 40 wherein the melt pool grows at approximately the angle of powder entry relative to a main body of the structure.

42. The method of claim 41 wherein at least a portion of the overhang comprises the angle of powder entry of the at least one nozzle.

43. The method of claim 35 wherein the overhang is formed layer by layer.

44. The method of claim 35 wherein the nozzles are evenly spaced around the laser beam.

45. The method of claim 35 further comprising the step of adjusting the angle of powder entry of each nozzle.

46. The method of claim 35 further comprising the step of independently controlling the flow of powder through each nozzle.

47. The method of claim 35 wherein the disposing step comprises disposing an annular ring comprising the nozzles around the laser beam.

48. The method of claim 47 wherein the nozzles comprise the same angle of powder entry.

49. The method of claim 48 further comprising the step of changing the angle of powder entry by replacing the annular ring with a second annular ring comprising nozzles comprising a second angle of powder entry.

50. The method of claim 47 further comprising the step of replacing the annular ring with a nozzle housing comprising individual nozzles.

51. The method of claim 50 further comprising the step of replacing one or more of the individual nozzles.

52. The method of claim 35 further comprising the step of propelling powder to the target using one or more discrete nozzles arranged around the nozzles.

53. The method of claim 52 wherein the discrete nozzles each comprise an angle of powder entry between 0 and approximately 180°.

54. The method of claim 35 further comprising the step of translating the nozzles relative to the structure along at least one linear axis.

55. The method of claim 35 further comprising the step of rotating the nozzles relative to the structure along at least one rotational axis.
